(19) United States
(12) Patent Application Publication
(10) Pub. No.: US 2026/0273427 A1
(43) Pub. Date: Sep. 17, 2026

(54) GYRO DEVICE AND SENSITIVITY SETTING METHOD

(71) Applicant: FUTABA CORPORATION, Mobara-shi (JP)

(72) Inventors: Masahiro TANAKA, Mobara-shi (JP); Takatoshi MORITA, Mobara-shi (JP)

(21) Appl. No.: 19/562,957

(22) Filed: Mar. 11, 2026

(30) Foreign Application Priority Data
Mar. 17, 2025 (JP) 2025-042088

(51) Int. Cl. A63H 17/38; A63H 17/395; G01C 21/18

(52) U.S. Cl. CPC A63H 17/38; A63H 17/395; G01C 21/18; A63H 2200/00

(57) ABSTRACT

A gyro device configured to calculate a steering control value for posture stability control of a model automobile based on detection information from an angular velocity sensor is disclosed. The gyro device includes a linked setting processing part configured to change setting of response sensitivity to a steering operation in association with changes in setting of control sensitivity of the posture stability control.

### CROSS-REFERENCE TO RELATED APPLICATIONS

This application claims priority to Japanese Patent Application No. 2025-042088 filed on Mar. 17, 2025, the entire contents of which are incorporated herein by reference.

### TECHNICAL FIELD

The present disclosure relates to a gyro device for calculating a steering control value for posture stability control of a model automobile based on detection information from an angular velocity sensor, and a sensitivity setting method for the gyro device; and, more particularly, to a technology for setting response sensitivity to a steering operation.

### BACKGROUND

A gyro device that calculates a steering control value for posture stability control of a model automobile based on detection information from an angular velocity sensor is known. The gyro device may adjust control sensitivity for posture stability control.

Japanese Laid-open Patent Publication No. 2024-157847 and Japanese Laid-open Patent Publication No. 2022-65402 are examples of related prior art. Both publications disclose a technology for performing posture stability control using a gyro sensor in a control system for a model airplane.

### SUMMARY

Here, as the control sensitivity of the posture stability control increases, the posture stability (straightness) of a model automobile increases, but the operational responsiveness that is the responsiveness to a steering operation tends to deteriorate as a trade-off relationship. In a model automobile with a function for adjusting the response sensitivity to the steering operation, the decrease in the operational responsiveness caused by the increase in the control sensitivity can be suppressed by performing adjustment for increasing the response sensitivity. However, currently, the response sensitivity is manually adjusted by a user, and the user is forced to adjust the response sensitivity whenever the control sensitivity is adjusted.

The present disclosure has been made in view of the above circumstances, and aims to reduce the operational burden on a user regarding the adjustment of the control sensitivity of the posture stability control and the adjustment of the response sensitivity to the steering operation associated therewith.

The gyro device of the present disclosure is configured to calculate a steering control value for posture stability control of a model automobile based on detection information from an angular velocity sensor, and includes a linked setting processing part that changes the setting of the response sensitivity to the steering operation in association with the change in the setting of the control sensitivity of the posture stability control.

Since the change in the setting of the response sensitivity is associated with the change in the setting of the control sensitivity as described above, a user does not need to adjust the response sensitivity whenever the control sensitivity is adjusted.

Further, the sensitivity setting method of the present disclosure is the sensitivity setting method for the gyro device that calculates a steering control value for posture stability control of a model automobile based on detection information from an angular velocity sensor, and changes the setting of the response sensitivity to the steering operation in association with the change in the setting of the control sensitivity of the posture stability control.

With the sensitivity setting method described above, the same effects as those of the above-described gyro device of the present disclosure can be obtained.

According to the present disclosure, it is possible to reduce the operational burden on a user regarding the adjustment of the control sensitivity of the posture stability control and the adjustment of the response sensitivity to the steering operation associated therewith.

### BRIEF DESCRIPTION OF THE DRAWINGS

FIG. 1 is a diagram showing a configuration example of a radio control system according to an embodiment of the present disclosure.

FIG. 2 is a diagram showing an internal configuration example of a model automobile and a transmitter according to an embodiment.

FIG. 3 is a block diagram showing an internal configuration example of a gyro device according to an embodiment.

FIG. 4 is a functional block diagram for explaining functions of a processor in the gyro device according to an embodiment.

FIG. 5 is a diagram showing an example of a gyro setting screen.

FIGS. 6A and 6B are diagrams for explaining an example of response sensitivity characteristics employed in an embodiment.

FIG. 7 is a diagram showing an example of control sensitivity/response sensitivity correspondence information in an embodiment.

FIG. 8 is a flowchart showing an example of a specific processing procedure to be executed to implement a sensitivity setting method according to an embodiment.

FIG. 9 is a flowchart of processing corresponding to a case where a setting instruction for an adjustment value of response sensitivity is performed separately from a setting instruction for control sensitivity.

FIG. 10 is a diagram for explaining a configuration example of a gyro device according to a modified example.

FIG. 11 is a diagram showing examples of first and second control sensitivity/response sensitivity correspondence information in a modified example.

FIG. 12 is a flowchart showing an example of a specific processing procedure to be executed to implement a sensitivity setting method according to a modified example.

### DETAILED DESCRIPTION

Hereinafter, embodiments of the present disclosure will be described in the following order:
<1. Overview of configuration of radio control system>
<2. Configuration of transmitter and model automobile>
<3. Configuration of gyro device>
<4. Sensitivity setting method according to an embodiment>
<5. Processing procedure>
<6. Modified example>
<7. Summary of embodiments>

### 1. OVERVIEW OF CONFIGURATION OF RADIO CONTROL SYSTEM

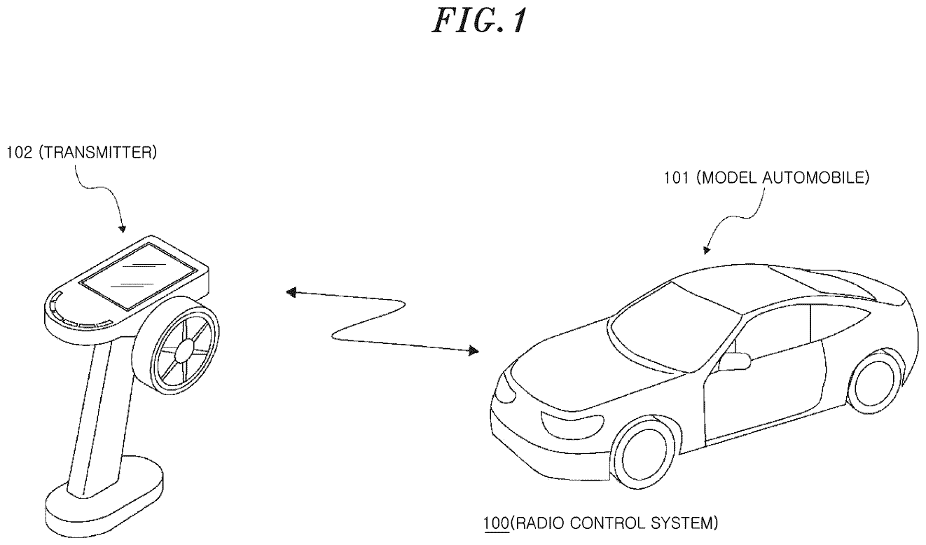

FIG. 1 is a diagram showing a configuration example of a radio control system 100 according to one embodiment.

As illustrated, the radio control system 100 includes a model automobile 101 as an object to be controlled, and a transmitter 102 that functions as a controller for wirelessly controlling the model automobile 101.

Although detailed illustration is omitted, the model automobile 101 in this example is configured as a four-wheeled vehicle with a total of four wheels, including a pair of front and a pair of rear wheels. A pair of left and right wheels as front wheels are provided as steering wheels for turning the model automobile 101, and a pair of left and right wheels as rear wheels are provided as driving wheels for moving the model automobile 101 forward or backward.

As will be described below, the model automobile 101 includes a receiver (receiver 111) that receives control signals from the transmitter 102, a travel servo motor (travel servo motor 112) that operates in response to the control signals, and a steering servo motor (steering servo motor 113). In particular, the model automobile 101 of the present embodiment includes a gyro device (gyro device 1) that realizes posture stability control based on information detected by an angular velocity sensor.

The transmitter 102 has a manipulation element for controlling the model automobile 101, specifically, for instructing at least the operations of the steering wheels and the driving wheels, and has a function of generating and transmitting control signals to the model automobile 101 in response to the manipulation of the manipulation element. The transmitter 102 of this example also has a function of wirelessly setting various types of information in the receiver or the gyro device of the model automobile 101, and also has a display part (display part 123 to be described below) that displays menu screens for various setting operations.

### 2. CONFIGURATION OF TRANSMITTER AND MODEL AUTOMOBILE

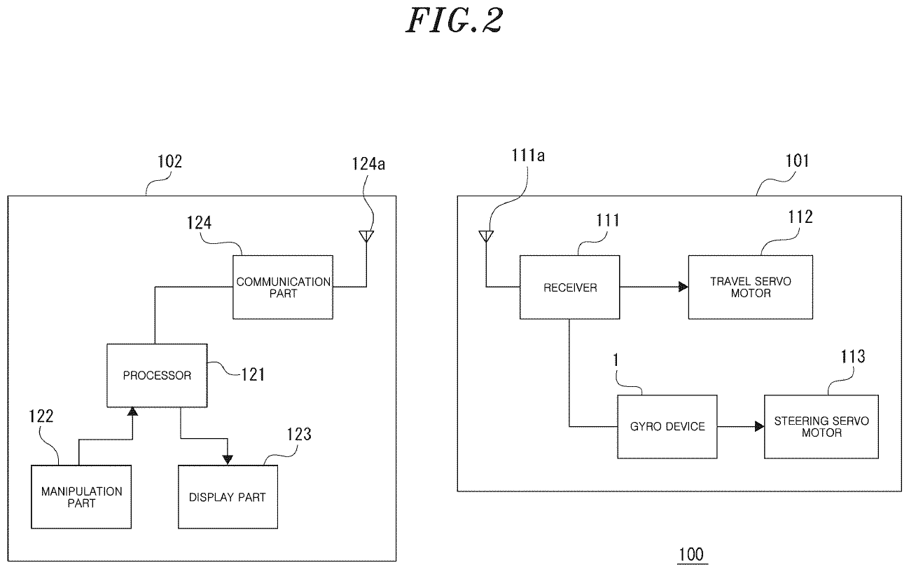

FIG. 2 is a block diagram showing an internal configuration example of the model automobile 101 and the transmitter 102.

As illustrated, the transmitter 102 includes a processor 121 configured as a calculation processing device such as a central processing unit (CPU), a manipulation part 122, the display part 123, and a communication part 124.

The manipulation part 122 includes at least a manipulation element for instructing the operations of the steering wheels and the driving wheels of the model automobile 101. Specifically, the manipulation part 122 includes, e.g., a wheel-shaped manipulation element for instructing a steering direction and a steering angle, and a trigger-shaped manipulation element for instructing a degree of acceleration/deceleration of the model automobile 101. Hereinafter, the manipulation element for instructing the steering direction and the steering angle will be referred to as “steering manipulation element” and the manipulation element for instructing a degree of acceleration/deceleration of the model automobile 101 will be referred to as “acceleration/deceleration manipulation element.”

The steering manipulation element and the acceleration/deceleration manipulation element are not limited to the wheel-shaped and the trigger-shaped manipulation elements exemplified above, and may be other-shaped manipulation elements such as lever-shaped manipulation elements and the like.

The manipulation part 122 of this example also includes a manipulation element for a user to configure various settings for the transmitter 102 and a manipulation element for manipulating a menu screen. The manipulation element for manipulating the menu screen may be a touch panel or the like.

The display part 123 has a display panel capable of displaying images, such as a liquid crystal display (LCD) panel or an organic electro luminescence (EL) panel, and displays various types of information to the user based on instructions from the processor 121. For example, it is possible to display the menu screen described above, various status information, such as the remaining battery level of the transmitter 102 and the like.

The communication part 124 has an antenna 124a, and performs wireless data communication with the receiver 111 of the model automobile 101 according to a predetermined wireless communication method.

The receiver 111 of this example has not only a data receiving function but also a data transmitting function. The communication part 124 has a function of not only transmitting control signals to the receiver 111, but also receiving data transmitted by the receiver 111. Accordingly, in the transmitter 102 of this example, the processor 121 can obtain information such as various setting values of the receiver 111 and the gyro device 1 of the model automobile 101.

The processor 121 performs processing for generating control signals in response to the manipulation of the steering manipulation element and the acceleration/deceleration manipulation element in the manipulation part 122, and transmitting the generated control signals to the receiver 111 of the model automobile 101 via the communication part 124. The processor 121 of this example also performs processing for displaying the menu screen and various status information on the display part 123 in response to the manipulation of the manipulation elements in the manipulation part 122, and transmitting information in response to the manipulation to the receiver 111 via the communication part 124.

The model automobile 101 includes the receiver 111, the travel servo motor 112, the gyro device 1, and the steering servo motor 113.

The receiver 111 has an antenna 111a, and performs wireless data communication with the communication part 124 of the transmitter 102 according to a predetermined wireless communication method.

The receiver 111 receives control signals from the transmitter 102. In this example, the control signals include acceleration/deceleration signals for instructing a degree of acceleration/deceleration of the model automobile 101, and steering signals for instructing the steering direction and the steering angle.

The receiver 111 outputs the acceleration/deceleration signals included in the received control signals to the travel servo motor 112, and outputs steering signals to the gyro device 1.

Although not illustrated, the model automobile 101 of this example is configured such that the driving wheels (rear wheels in this example) are driven by an engine (not shown) as a driving source, and the travel servo motor 112 is a servo motor for adjusting a carburetor in the engine. By controlling the rotational operation of the travel servo motor 112 in accordance with the acceleration/deceleration signals, the engine speed control is realized, thereby controlling a degree of acceleration/deceleration of the model automobile 101.

The model automobile 101 may also be configured such that the wheels are driven using a motor as a driving source. In this case, a travel motor is provided instead of the travel servo motor, and an electric speed controller (ESC) for controlling the travel motor is provided.

The gyro device 1 is one embodiment of the gyro device of the present disclosure, and calculates a steering control value for controlling the posture stability of the model automobile 101 based on detection information from the angular velocity sensor. The gyro device 1 adds the calculated steering control value to the steering signal inputted from the receiver 111, and outputs the steering signal after addition to the steering servo motor 113.

The internal configuration of the gyro device 1 will be described later.

Although not illustrated, in the model automobile 101, the rotational power of the steering servo motor 113 is transmitted to a steering mechanism that supports the steering wheels so that they can steer in the left-right direction. Therefore, by controlling the rotational operation of the steering servo motor 113 in response to the steering signal outputted by the gyro device 1 as described above, the steering of the model automobile 101 in response to the manipulation of the steering manipulation element is realized, and the posture stability control by the gyro device 1 is realized.

### 3. CONFIGURATION OF GYRO DEVICE

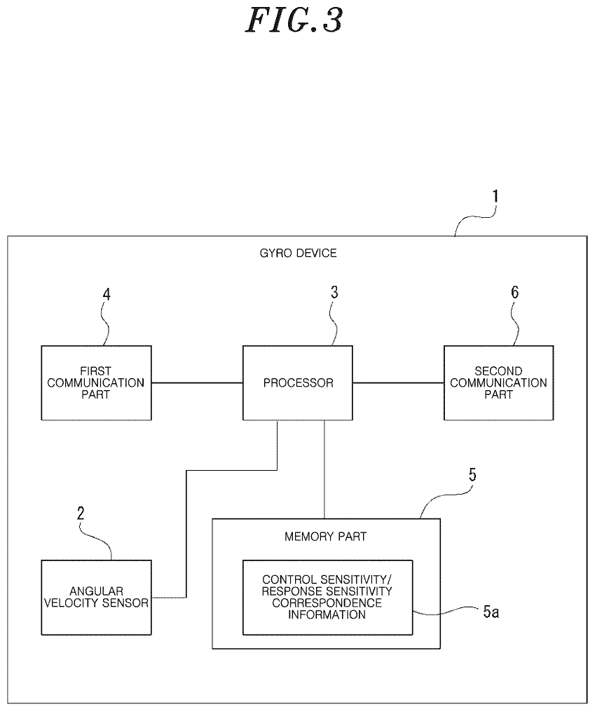

FIG. 3 is a block diagram showing an internal configuration example of the gyro device 1.

As illustrated, the gyro device 1 includes an angular velocity sensor 2, a processor 3, a first communication part 4, a memory part 5, and a second communication part 6.

The angular velocity sensor 2 detects an angular velocity. Specifically, the angular velocity sensor 2 detects the angular velocity of the model automobile 101 in the yaw direction. In practice, the gyro device 1 is attached to the model automobile 101 in an orientation that allows the angular velocity sensor 2 to detect the angular velocity in the yaw direction.

The first communication part 4 is a communication device for communicating data with the receiver 111, and the second communication part 6 is a communication device for communicating data with the steering servo motor 113.

The memory part 5 collectively refers to data storage devices, such as read only memory (ROM), random access memory (RAM), and other non-volatile memories, provided in the gyro device 1.

In the gyro device 1 of this example, the control sensitivity/response sensitivity correspondence information 5a is stored in the memory part 5, which will be described later.

The processor 3 includes a calculation processing device, such as a CPU, and realizes various operations of the gyro device 1 by executing processing according to programs stored in the memory part 5.

Specifically, the processor 3 performs processing for calculating a steering control value for the posture stability control of the model automobile 101 based on detection information from the angular velocity sensor 2.

The gyro device 1 of this example uses a proportional-integral-differential (PID) control method to perform the posture stability control of the model automobile 101 based on the detection information from the angular velocity sensor 2. Specifically, the posture stability control in this example is performed by calculating the steering control value yₙ using the following Eq. (1).

In Eq. (1), n is a value at time n, Kₚ is a control coefficient, eₙ is an angular velocity error, Iₙ is an integral control term, and Dₙ is a differential control term. Here, the angular velocity error eₙ refers to the error between the angular velocity detected by the angular velocity sensor 2 and the control target value (e.g., fixed value such as “0”) of the angular velocity.

$${y}_{n} = {K}_{p} [ {e}_{n} + {I}_{n} + {D}_{n} ] \qquad Eq . ( 1 )$$

The control target value of the angular velocity may also be a value that varies according to the value of the steering signal.

In PID control, the proportional control term Pₙ, the integral control term Iₙ, and the differential control term Dₙ are as shown in the following Eq. (2). In Eq. (2), n−1 is a value one sample before time n, T_{I} is an integral time, θ is a sampling period, η is a differential coefficient, and T_{D} is a differential time.

$$differential control term {P}_{n} = {K}_{p} \cdot {e}_{n} \qquad Eq . ( 2 )$$

$$integral control term {I}_{n} = {I}_{n - 1} + \frac{θ}{{T}_{I}} \cdot [ \frac{{e}_{n} + {e}_{n - 1}}{2} ]$$

$$differential control term {D}_{n} = {D}_{n - 1} + \frac{{T}_{D}}{θ + η {T}_{D}} ( {e}_{n} - {e}_{n - 1} ) - \frac{θ}{θ + η {T}_{D}} {D}_{n - 1}$$

The processor 3 adds the steering control value yₙ calculated based on the detection information from the angular velocity sensor 2 as described above to the value of the steering signal received from the receiver 111 via the first communication part 4, and outputs a steering signal based on the value after addition to the steering servo motor 113.

The processor 3 can variably set the control sensitivity for the posture stability control performed by calculating the steering control value yₙ as described above. Here, the control sensitivity of the posture stability control corresponds to the control coefficient Kₚ in Eq. (1).

In this example, a user can adjust the control sensitivity to any value within a predetermined range by manipulating the transmitter 102. In other words, in the transmitter 102, the processor 121 instructs the gyro device 1 with the control sensitivity value specified by the manipulation, and the processor 3 performs processing for setting the control sensitivity based on the instructed value.

### 4. SENSITIVITY SETTING METHOD AS EMBODIMENT

Here, when the control sensitivity of the posture stability control is adjustable, the increase in the control sensitivity improves the posture stability (straightness) of the model automobile. However, the operational responsiveness, which is responsiveness to the steering operation, tends to decrease.

If there is a function of adjusting the response sensitivity to a steering operation, the decrease in the operational responsiveness caused by increasing the control sensitivity can be suppressed by performing adjustment for increasing the response sensitivity. However, currently, the response sensitivity is adjusted manually by a user, and the user is forced to adjust the response sensitivity whenever the control sensitivity is adjusted.

Therefore, the present embodiment aims to reduce the operational burden on a user regarding the adjustment of the control sensitivity of posture stability control and the adjustment of the response sensitivity to the steering operation associated therewith.

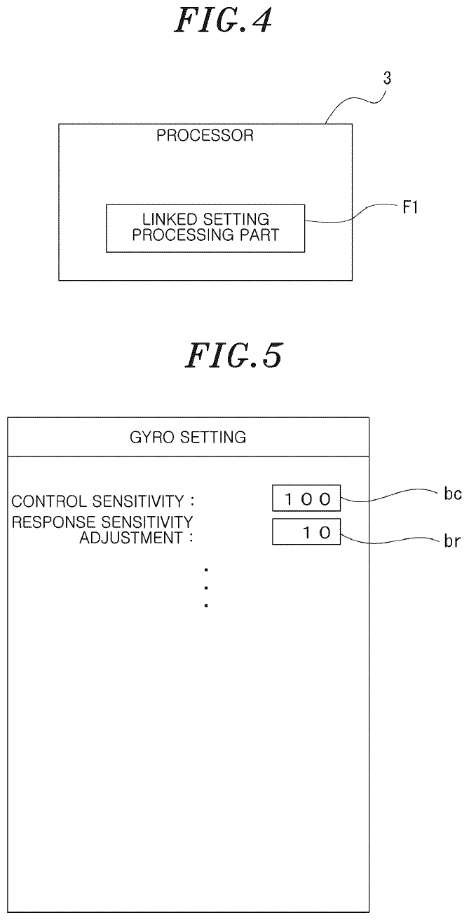

To this end, the processor 3 of the present embodiment functions as a linked setting processing part F1 shown in FIG. 4.

The linked setting processing part F1 changes the setting of the response sensitivity to the steering operation in association with the change in the setting of the control sensitivity of the posture stability control.

For clarity, the sensitivity refers to the magnification of the output value relative to the input value (input/output magnification).

By changing the setting of the response sensitivity in association with the change in the setting of the control sensitivity as described above, the user does not need to adjust the response sensitivity whenever the control sensitivity is adjusted.

Therefore, it is possible to reduce the operational burden on the user regarding the adjustment of the control sensitivity and the adjustment of the response sensitivity to the steering operation associated therewith.

Hereinafter, a specific example of the flow from the user's operation of adjusting the control sensitivity to the linked setting of the response sensitivity will be described.

FIG. 5 shows an example of a gyro setting screen displayed on the display part 123 of the transmitter 102.

As illustrated, the gyro setting screen is provided with an input box bc for inputting a control sensitivity value. A user can input the control sensitivity value in the input box bc by manipulating the transmitter 102. Due to predetermined manipulation, such as pressing an enter button, the inputted control sensitivity value is instructed from the transmitter 102 to the gyro device 1. In the gyro device 1, the processor 3 sets the value of the control sensitivity to the value instructed by the transmitter 102, as described above.

The linked setting processing part F1 of the processor 3 performs processing for setting a value of the response sensitivity to the steering operation to a value corresponding to the instructed control sensitivity value, in response to the control sensitivity value instructed from the transmitter 102.

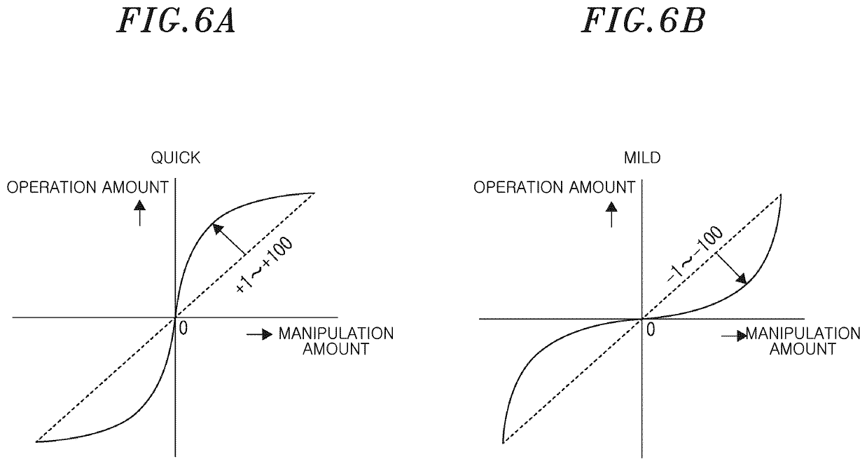

FIGS. 6A and 6B are diagrams for explaining an example of response sensitivity characteristics employed in an embodiment.

In FIGS. 6A and 6B, the response sensitivity characteristics are illustrated with the horizontal axis representing a manipulation amount (i.e., steering signal value) and the vertical axis representing a steering operation amount (i.e., steering angle). FIG. 6A illustrates the quickest characteristics with maximum response sensitivity, while FIG. 6B illustrates the mildest characteristics with minimum response sensitivity.

In this example, the response sensitivity value can be set within a range from 100 to −100.

For clarity, the response sensitivity characteristics refer to characteristics of changes in the operation amount with respect to changes in the steering angle. Here, in this example, the response sensitivity characteristics are common characteristics regardless of the steering direction (left-right direction).

When the value of the response sensitivity is 0, as indicated by dotted lines in FIGS. 6A and 6B, the response sensitivity characteristics become linear characteristics in which the manipulation amount and the operation amount are the same. Regardless of whether the response sensitivity value is positive or negative, in a region where the absolute value of the response sensitivity is greater than 0, the response sensitivity characteristics become curved characteristics in which the value of the operation amount changes quadratically (exponentially) with respect to an increase in the absolute value of the manipulation amount.

Specifically, when the response sensitivity value is a positive value (see FIG. 6A), the response sensitivity characteristics allow the magnification (i.e., the input-output magnification described above) of the operation amount (output value) with respect to the manipulation amount (input value) in an initial steering region to be maximum.

On the contrary, when the response sensitivity value is a negative value (see FIG. 6B), the response sensitivity characteristics allow the input-output magnification in the initial steering region to be minimum.

In this example, the response sensitivity characteristics allow a degree of curvature to increase as the response sensitivity value increases.

By setting the response sensitivity characteristics as described above, in this example, as the response sensitivity value gradually increases to a value greater than 0, the input-output magnification gradually increases due to an increase in the curvature, resulting in quicker steering responsiveness. On the contrary, as the response sensitivity value gradually decreases to a value less than 0, the input-output magnification gradually decreases, resulting in milder steering responsiveness.

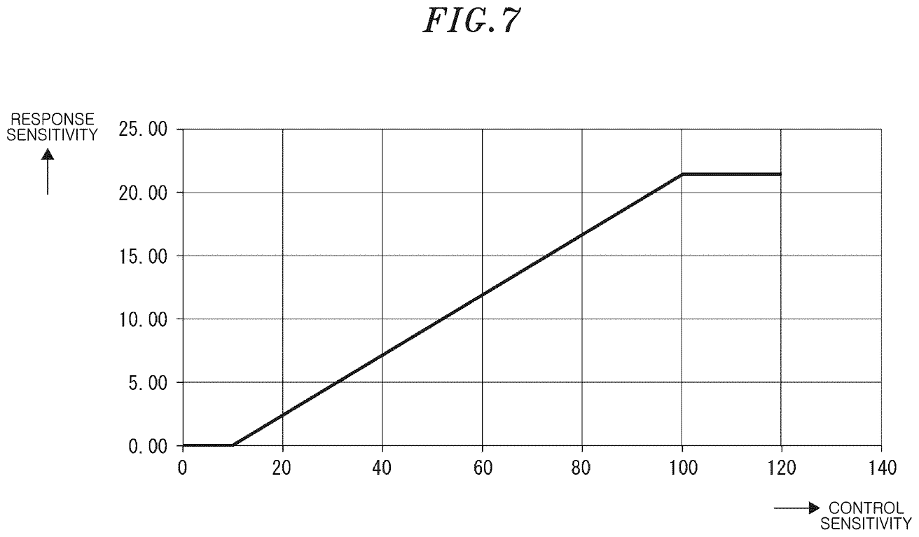

As described above, the increase in the control sensitivity of the posture stability control leads to the decrease in the steering responsiveness. Therefore, the linked setting processing part F1 of this example sets the response sensitivity to have positive correlation with the control sensitivity. In this case, the linked setting requires enhanced steering responsiveness (i.e., quick characteristics), so that values in the negative range shown in FIG. 6B are not used for the response sensitivity value. In other words, the range of the response sensitivity value set in association with the control sensitivity is 0 or greater (see FIG. 7 to be described below).

In this example, it is assumed that the appropriate correspondence between the response sensitivity and the control sensitivity is predetermined based on the results of driving tests conducted to check the steering feeling while changing combination of settings of the control sensitivity and the response sensitivity.

FIG. 7 shows an example of control sensitivity/response sensitivity correspondence information 5a indicating the correspondence between the control sensitivity and the response sensitivity obtained from the results of the driving tests.

In this example, the control sensitivity/response sensitivity correspondence information 5a is stored in the memory part 5 as table information in which the response sensitivity values are associated with the control sensitivity values.

In the control sensitivity/response sensitivity correspondence information 5a, the response sensitivity value basically increases in response to an increase in the control sensitivity value. However, the control sensitivity/response sensitivity correspondence information 5a of this example includes a dead zone where the response sensitivity value remains unchanged despite an increase in the control sensitivity value, in addition to a region where the response sensitivity value increases with respect to an increase in the control sensitivity value. Specifically, in the control sensitivity/response sensitivity correspondence information 5a of this example, the dead zone is provided in a region where the control sensitivity value is close to 0 and a region where the control sensitivity value is close to the maximum value.

When the control sensitivity setting instruction is issued in response to the manipulation of the transmitter 102 described above, the linked setting processing part F1 refers to the control sensitivity/response sensitivity correspondence information 5a to identify the response sensitivity value corresponding to the instructed control sensitivity. Further, the linked setting processing part F1 performs processing for updating the set value of the response sensitivity based on the identified response sensitivity value.

In the radio control system 100 of this example, the response sensitivity value is not limited to being set to a preset value identified from the control sensitivity value as described above, and the response sensitivity may be adjusted from the preset value.

In this example, the response sensitivity value can be adjusted through the gyro setting screen described above.

Specifically, as shown in FIG. 5, the gyro setting screen in this example is provided with the input box br for inputting the adjustment value of the response sensitivity. A user can input the adjustment value of the response sensitivity into the input box br by manipulating the transmitter 102. Here, the adjustment value of the response sensitivity refers to a value indicating the adjustment amount for the response sensitivity value identified from the control sensitivity value by the linked setting processing unit F1, as described above. In other words, it is a value indicating an increased/decreased amount of the response sensitivity from the identified response sensitivity value.

By performing predetermined manipulation, such as manipulation of an enter button, the inputted adjustment value of the response sensitivity is instructed from the transmitter 102 to the gyro device 1.

When the adjustment value for the response sensitivity is instructed by manipulation, the linked setting processing part F1 updates the set value of the response sensitivity based on the adjustment value. Specifically, the set value of the response sensitivity is updated by a value obtained by adding the adjustment value to the response sensitivity value identified from the control sensitivity value, i.e., the response sensitivity value as the preset value determined to correspond to the control sensitivity value.

Accordingly, it is possible to adjust the set value of the response sensitivity to a value other than the response sensitivity as the preset value determined to correspond to the control sensitivity.

Hence, a customization function for steering feel under posture stability control can be provided.

As described above, in the present embodiment, the response sensitivity is set in association with the setting of the control sensitivity. In this case, the characteristics of the response sensitivity set in association with the setting of the control sensitivity allow the input/output magnification to be maximum in the initial steering region, as described with reference to FIGS. 6A and 6B.

Depending on the posture stability control, the steering responsiveness tends to be particularly poor at the beginning of steering. Since the response sensitivity characteristics allow the input-output magnification to be maximum in the initial steering region as described above, it is possible to appropriately suppress the decrease in the steering responsiveness at the beginning of steering.

### 5. PROCESSING PROCEDURE

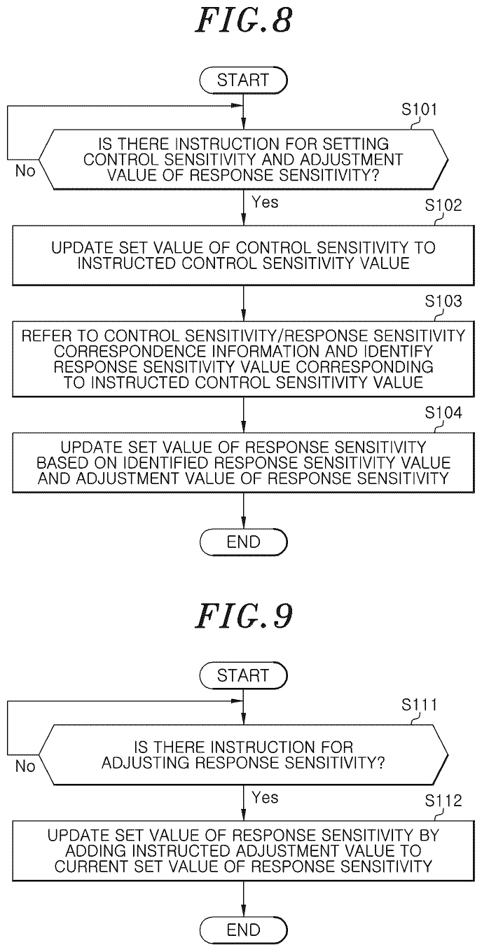

An example of a specific processing procedure to be executed by the processor 3 to implement the sensitivity setting method of the above-described embodiment will be described with reference to the flowchart in FIG. 8.

The processor 3 executes the processing shown in FIG. 8 based on the program stored in the memory part 5.

First, in step S101, the processor 3 waits for an instruction for setting the control sensitivity and an adjustment value of the response sensitivity. For example, it is assumed that the instruction for setting the control sensitivity and the adjustment value of the response sensitivity from the transmitter 102 in response to the manipulation on the gyro setting screen shown in FIG. 5 is performed before the manipulation of the model automobile 101. In step S101, the processor 3 waits for the instruction for setting the control sensitivity and the adjustment value of the response sensitivity from the transmitter 102 at the pre-manipulation stage.

When it is determined in step S101 that there was an instruction for setting the control sensitivity and the adjustment value of the response sensitivity, the processor 3 proceeds to step S102 and performs processing for updating the set value of the control sensitivity to the instructed control sensitivity value.

For clarity, the processor 3 uses the set value of the control sensitivity as the control sensitivity value (in this example, the control coefficient Kₚ described above) for the posture stability control.

In step S103 subsequent to step S102, the processor 3 refers to the control sensitivity/response sensitivity correspondence information 5a to identify the response sensitivity value corresponding to the instructed control sensitivity value.

Then, in step S104 subsequent thereto, the processor 3 performs processing for updating the set value of the response sensitivity based on the identified response sensitivity value and the adjustment value of the response sensitivity. In other words, the set value of the response sensitivity is updated by a value obtained by adding the adjustment value of the response sensitivity instructed from the transmitter 102 to the response sensitivity value identified in step S103.

For clarity, the processor 3 uses the information on the input-output magnification of the steering signal, which is identified from the set value of the response sensitivity, for the steering signal adjustment processing for steering feeling adjustment. The steering control value yₙ calculated in the posture stability control is added to the steering signal after the adjustment processing has been performed, and the steering signal value after addition is outputted to the steering servo motor 113.

The processor 3 ends a series of processes shown in FIG. 8 upon execution of the processing of step S104.

Although it is assumed in the above description that the instruction for setting the control sensitivity and the instruction for setting the adjustment value of the response sensitivity are issued simultaneously, it is also possible to assume a case where the instruction for setting the control sensitivity and the instruction for setting the adjustment value of the response sensitivity are issued separately.

The flowchart of FIG. 9 shows processing corresponding to a case where the instruction for setting the adjustment value of the response sensitivity is issued separately from the instruction for setting the control sensitivity.

In step S111, the processor 3 waits for the instruction for adjusting the response sensitivity. In other words, the processor 3 waits for the instruction for setting the adjustment value of the response sensitivity from the transmitter 102.

When it is determined in step S111 that there was an instruction for adjusting the response sensitivity, the processor 3 proceeds to step S112 and updates the set value of the response sensitivity to a value obtained by adding the instructed adjustment value to the current set value of the response sensitivity.

Accordingly, the response sensitivity value can be appropriately adjusted in response to the case where the instruction for setting the adjustment value of the response sensitivity is issued separately from the instruction for setting the control sensitivity, such as a case where the control sensitivity and the response sensitivity are adjusted on separate screens.

The processor 3 ends a series of processing shown in FIG. 9 upon execution of the processing of step S112.

### 6. MODIFIED EXAMPLES

Although the embodiments of the present disclosure have been described above, the present disclosure is not limited to the specific examples described above, and various modified examples can be adopted.

For example, although the case where the posture stability control is performed by the PID control method has been described, the control method for the posture stability control is not limited to the PID control method, and other control methods such as a PD control method and the like may also be adopted.

Here, regarding the posture stability control, it has been found that when the control calculation methods are different, the relationship between changes in the control sensitivity and the degree of decrease in the steering responsiveness also differs. Therefore, when the control calculation method for the posture stability control is switchable, it is conceivable to vary the change characteristics of the response sensitivity with respect to changes in the control sensitivity according to the switching of the control calculation method.

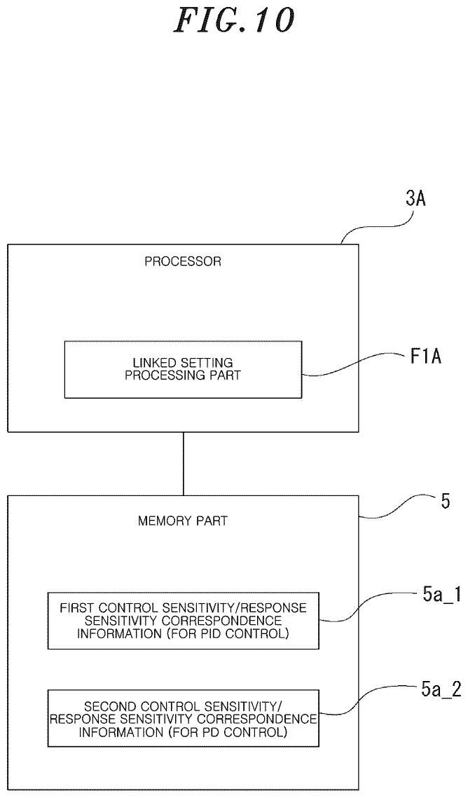

FIG. 10 is a diagram for explaining a configuration example of a gyro device 1A as a modified example that performs processing according to the switching of the control method.

Since the hardware configuration of the gyro device 1A is the same as that of the gyro device 1, redundant description thereof will be avoided. In FIG. 10, the processor 3 of the gyro device 1A is referred to as “processor 3A” so as to be distinguished from the processor 3 of the gyro device 1.

In the gyro device 1A, the processor 3A is configured to switch multiple control methods with different control calculation methods for the posture stability control. Specifically, in this example, the processor 3A is configured to switch the posture stability control using the PID control method and the posture stability control using the PD control method. In the PD control method, the steering control value yₙ is calculated using an equation in which the integral control term Iₙ is excluded from Eq. (1).

The memory part 5 of the gyro device 1A stores the control sensitivity/response sensitivity correspondence information 5a for each posture stability control method. Specifically, in this example, first control sensitivity/response sensitivity correspondence information 5a_1, which is the control sensitivity/response sensitivity correspondence information 5a for the PID control, and second control sensitivity/response sensitivity correspondence information 5a_2, which is the control sensitivity/response sensitivity correspondence information 5a for the PD control, are stored.

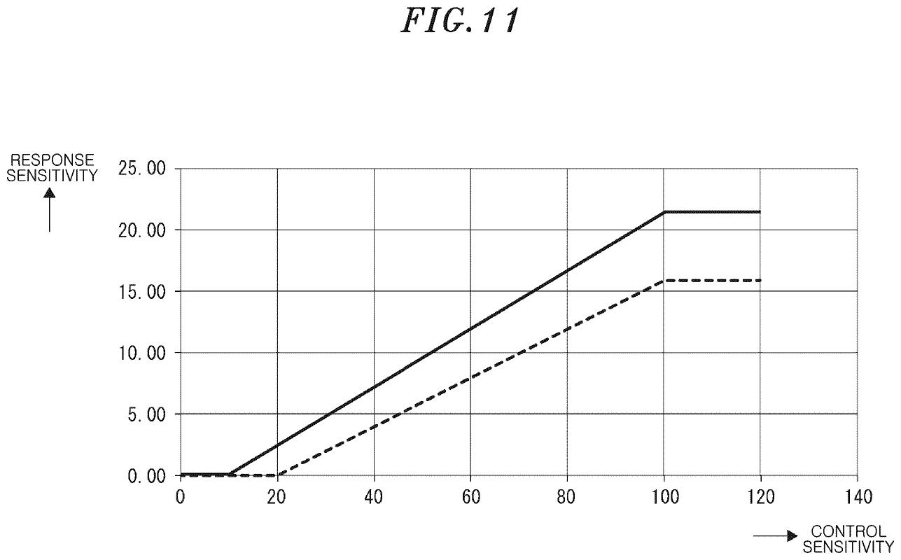

FIG. 11 is an explanatory diagram of examples of the first control sensitivity/response sensitivity correspondence information 5a_1 and the second control sensitivity/response sensitivity correspondence information 5a_2 (for PD control).

In FIG. 11, the characteristics indicated by the solid line denote the characteristics of first control sensitivity/response sensitivity correspondence information 5a_1 (for PID control), which are the same characteristics as those of the control sensitivity/response sensitivity correspondence information 5a shown in FIG. 7. The characteristics indicated by the dotted line denote the characteristics of second control sensitivity/response sensitivity correspondence information 5a_2 (for PD control). In this example, the second control sensitivity/response sensitivity correspondence information 5a_2 also partially has a dead zone. Specifically, the dead zone is provided in a region where the control sensitivity is close to 0 and a region where the control sensitivity is close to the maximum value. In a region (hereinafter, referred to as “active zone”) other than the dead zones in the second control sensitivity/response sensitivity correspondence information 5a_2, the characteristics that the response sensitivity increases as the control sensitivity value increases (i.e., positive correlation characteristics) are obtained. However, in the active zone of the second control sensitivity/response sensitivity correspondence information 5a_2, the response sensitivity value is lower across the entire range compared to the first control sensitivity/response sensitivity correspondence information 5a_1. This is because a degree of decrease in the steering responsiveness caused by the posture stability control is smaller in the case of the PD control method.

In FIG. 10, the processor 3A is different from the processor 3 in that it includes a linked setting processor F1A instead of the linked setting processor F1. The linked setting processor F1A varies the change characteristics of the response sensitivity with respect to changes in the control sensitivity according to the control method of the posture stability control. Specifically, in the case of performing the posture stability control by the PID control method, the linked setting processor F1A performs processing using the first control sensitivity/response sensitivity correspondence information 5a_1 as the processing for identifying the response sensitivity according to the control sensitivity, and in the case of performing the posture stability control by the PD control scheme, the linked setting processor F1A performs the processing using the second control sensitivity/response sensitivity correspondence information 5a_2 as the processing for identifying the response sensitivity according to the control sensitivity.

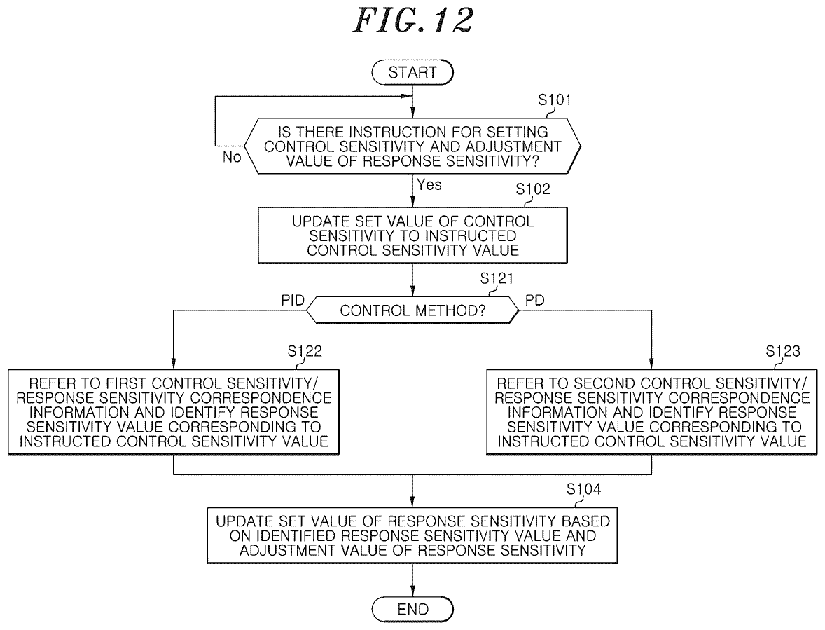

The flowchart of FIG. 12 shows an example of a processing procedure to be executed by the processor 3A to implement a sensitivity setting method as the modified example described above.

The processing shown in FIG. 12 is different from the processing shown in FIG. 8 in that the processing of step S103 is omitted and the processing of steps S121 to S123 is added instead.

Upon execution of the update processing of step S102, the processor 3A checks the control method in step S121. In other words, it is determined whether the control method of the posture stability control is the PID control method or the PD control method.

When it is determined in step S121 that the control method is the PID control method, the processor 3A proceeds to step S122, refers to the first control sensitivity/response sensitivity correspondence information 5a_1, and identifies the response sensitivity value corresponding to the instructed control sensitivity value.

On the contrary, when it is determined in step S121 that the control method is the PD control method, the processor 3A proceeds to step S123, refers to the second control sensitivity/response sensitivity correspondence information 5a_2, and identifies the response sensitivity value corresponding to the instructed control sensitivity value.

Upon execution of the processing of one of step S122 and step S123, the processor 3A proceeds to step S104, and performs processing for updating the set value of the response sensitivity based on the identified response sensitivity value and the adjustment value of the response sensitivity.

The processor 3A ends a series of processing shown in FIG. 12 upon execution of the processing of step S104.

The switching between the PID control method and the PD control method is merely an example of the control method for posture stability control, and other types of switching, such as the switching between the PID control method and the PI control method, can also be considered.

### 7. SUMMARY OF EMBODIMENTS

As described above, the gyro devices 1 and 1A according to the embodiments calculate the steering control value for posture stability control of a model automobile based on the detection information from the angular velocity sensor, and respectively include the linked setting processing parts F1 and F1A that change the setting of the response sensitivity to the steering operation in association with the change in the setting of the control sensitivity for posture stability control.

By changing the setting of the response sensitivity in association with the change in the setting of the control sensitivity as described above, a user does not need to adjust the response sensitivity whenever the control sensitivity is adjusted.

Accordingly, it is possible to reduce the operational burden on the user regarding the adjustments of the control sensitivity and the adjustment of the response sensitivity to the steering operation associated therewith.

Further, in the gyro device according to the embodiment, the linked setting processing part sets the response sensitivity to have the positive correlation with the control sensitivity (see FIG. 7 or the like).

When the control sensitivity of the posture stability control increases, the posture stability (straightness) of the model automobile increases, but the manipulation responsiveness that is the responsiveness to the steering operation tends to decrease, as a trade-off relationship. By setting the response sensitivity to have the positive correlation with the control sensitivity as described above, i.e., by performing linked setting such that the response sensitivity increases as the control sensitivity increases, it is possible to suppress a decrease in the steering responsiveness caused by an increase in the control sensitivity.

Hence, the posture stability control can be achieved while suppressing a decrease in the steering responsiveness.

Further, in the gyro device according to the embodiment, the response sensitivity characteristics allow the input/output magnification, which is the magnification of the output value to the input value, to become maximum in the initial steering region (see FIGS. 6A and 6B).

Depending on the posture stability control, the steering responsiveness tends to decrease particularly at the beginning of steering. Since the response sensitivity characteristics allow the input/output magnification to become maximum in the initial steering region as described above, it is possible to appropriately suppress deterioration in the steering responsiveness at the beginning of steering.

Therefore, the posture stability control can be achieved while suppressing a decrease in the steering responsiveness.

Further, in the gyro device according to the embodiment, when the adjustment value for the response sensitivity is instructed by manipulation, the linked setting processing part updates the set value of the response sensitivity by a value obtained by adding the adjustment value to the response sensitivity value as the preset value determined to correspond to the control sensitivity value.

Accordingly, it is possible to adjust the set value of the response sensitivity to a value other than the response sensitivity as the preset value determined to correspond to the control sensitivity.

Hence, a customization function for steering feel under posture stability control can be provided.

Further, in the gyro device 1A according to the embodiment, multiple control methods with different control calculation methods are switchable for the posture stability control, and the linked setting processing part F1A varies the change characteristics of the response sensitivity with respect to changes in the control sensitivity according to the control method of the posture stability control.

When the control methods with different control calculation methods, such as PID control and PD control, are switchable for the posture stability control, the deterioration in the steering responsiveness with respect to changes in the control sensitivity may be different depending on the control methods. By varying the change characteristics of the response sensitivity with respect to changes in the control sensitivity depending on the control methods for the posture stability control as described above, it is possible to appropriately perform linked setting of the response sensitivity according to the deterioration characteristics of the steering responsiveness in each control method.

Therefore, regardless of types of the control methods, it is possible to suppress deterioration in the steering responsiveness caused by the posture stability control.

The sensitivity setting method according to the embodiment is the sensitivity setting method for the gyro device that calculates the steering control value for the posture stability control of the model automobile based on the detection information from the angular velocity sensor, and changes the setting of the response sensitivity to the steering operation in association with the change in the setting of the control sensitivity of the posture stability control.

With the sensitivity setting method described above, the same effects as those of the above-described gyro device of the present disclosure can be obtained.

1. A gyro device configured to calculate a steering control value for posture stability control of a model automobile based on detection information from an angular velocity sensor, comprising:
a linked setting processing part configured to change setting of response sensitivity to a steering operation in association with changes in setting of control sensitivity of the posture stability control.

2. The gyro device of claim 1, wherein the linked setting processing part is configured to set the response sensitivity to have positive correlation with the control sensitivity.

3. The gyro device of claim 2, wherein the response sensitivity has characteristics that allow an input/output magnification, which is a magnification of an output value relative to an input value, to become maximum in an initial steering region.

4. The gyro device of claim 1, wherein when an adjustment value of the response sensitivity is instructed by manipulation, the linked setting processing part is configured to update a set value of the response sensitivity by a value obtained by adding the adjustment value to a value of the response sensitivity as a preset value determined to correspond to a value of the control sensitivity.

5. The gyro device of claim 1, wherein a plurality of control methods with different control calculation methods are configured to be switchable for the posture stability control, and
the linked setting processing part is configured to vary change characteristics of the response sensitivity with respect to changes in the control sensitivity depending on control methods for the posture stability control.

6. The gyro device of claim 2, wherein a plurality of control methods with different control calculation methods are configured to be switchable for the posture stability control, and
the linked setting processing part is configured to vary change characteristics of the response sensitivity with respect to changes in the control sensitivity depending on control methods for the posture stability control.

7. The gyro device of claim 3, wherein a plurality of control methods with different control calculation methods are configured to be switchable for the posture stability control, and
the linked setting processing part is configured to vary change characteristics of the response sensitivity with respect to changes in the control sensitivity depending on control methods for the posture stability control.

8. The gyro device of claim 4, wherein a plurality of control methods with different control calculation methods are configured to be switchable for the posture stability control, and
the linked setting processing part is configured to vary change characteristics of the response sensitivity with respect to changes in the control sensitivity depending on control methods for the posture stability control.

9. A sensitivity setting method for a gyro device that calculates a steering control value for posture stability control of a model automobile based on detection information from an angular velocity sensor, comprising:
changing setting of response sensitivity to a steering operation in association with changes in setting of control sensitivity for the posture stability control.
